(19) United States
(12) Patent Application Publication
(10) Pub. No.: US 2026/0054462 A1
(43) Pub. Date: Feb. 26, 2026

(54) BODYMAKER AIRSTRIP AIRFLOW MONITORING AND OPTIMIZATION SYSTEM AND METHOD

(71) Applicant: Stolle Machinery Company, LLC, Centennial, CO (US)

(72) Inventors: Sayon Chandrakanthan, Lakewood, CO (US); Andrew Christopher Hyde, Littleton, CO (US); John James Silver, Lakewood, CO (US); Dan S. Prystawsky, Lake in the Hills, IL (US); Stephen Dane Christensen, Highlands Ranch, CO (US)

(73) Assignee: Stolle Machinery Company, LLC, Centennial, CO (US)

(21) Appl. No.: 19/306,406

(22) Filed: Aug. 21, 2025

Related U.S. Application Data
(60) Provisional application No. 63/686,327, filed on Aug. 23, 2024.

(51) Int. Cl. B30B 15/32; B30B 11/26

(52) U.S. Cl. CPC B30B 15/32; B30B 11/26

(57) ABSTRACT

A can bodymaker includes a ram including a punch and an air conduit, wherein the ram is structured to reciprocate, and an air strip system structured to receive pressurized air and to selectively provide the pressurized air to the punch via the air conduit to strip a can body off of the punch. The air strip system includes an air strip valve disposed on a reciprocating component of the can bodymaker, wherein the air strip valve is structured to selectively open to provide pressurized air to the punch and to close to stop providing pressurized air to the punch.

### CROSS REFERENCE TO RELATED APPLICATION

This application claims priority to U.S. Provisional Patent Application Ser. No. 63/686,327, filed Augst 23, 2024, entitled, Bodymaker Airstrip Airflow Monitoring And Optimization System And Method.

### FIELD OF THE INVENTION

The disclosed concept relates generally to can manufacturing, and more particularly to bodymakers used in can manufacturing.

### BACKGROUND OF THE INVENTION

Generally, an aluminum can begins as a sheet of aluminum from which a circular blank is cut. The blank is formed into a “cup” having a bottom and a depending sidewall. The cup is fed into a can bodymaker which passes the cup through a toolpack that thins and elongates the cup, thus forming a can body. That is, the cup is disposed on a punch mounted on an elongated ram. The ram is structured to reciprocate and pass the cup through the toolpack which (re)draws and irons the cup. That is, on each forward stroke of the ram, a cup is passed through the toolpack which forms the cup into the can body. Near the start of the return stroke, the now elongated can body is removed from the ram prior to the punch passing backward through the toolpack. A new cup is disposed on the punch prior to the punch passing forward again through the toolpack. Following additional finishing operations, e.g. trimming, washing, printing, etc., each can body is sent to a filler which fills the can body with product. A top is then coupled to, and sealed against, the can body, thereby completing the can.

The toolpack in the can bodymaker has multiple, spaced dies, each die having a substantially circular opening. Each die opening is slightly smaller than the next adjacent upstream die. Thus, when the punch draws the cup through the first die, the redraw die, the aluminum cup is deformed over the substantially cylindrical punch. Because the openings in the subsequent downstream dies of the toolpack have a smaller inner diameter, i.e. a smaller opening, the aluminum cup is thinned as the ram moves the punch and aluminum cup thereon through the rest of the toolpack.

After the cup (now generally in the shape of the can body) has moved through the last die, the cup bottom and sidewall have the desired thickness; the only other deformation required is to shape the bottom of the cup into an inwardly extending (i.e., concave) dome. To accomplish this, the distal end of the punch is concave while at the maximum extension of the ram is a generally convex dome element (having a shaped perimeter) commonly referred to as a “domer.” As the ram reaches its maximum extension, the bottom of the can body engages the domer and is deformed into a dome and the bottom perimeter of the can body is shaped as desired (typically angled inwardly so as to increase the strength of the can body and to allow for the resulting cans to be stacked). As the ram withdraws, the can body is stripped off of the end of the punch by injecting air into the center of the ram. The air travels through the ram and exits out of the end of the punch and breaks the can body loose from the punch. The ram is withdrawn through the toolpack, a new cup is deposited on the punch, and the cycle repeats.

It is important that the can body is properly stripped off of the end of the punch. The can body can be damaged in the process, or if the can body fails to break looks from the punch, manufacturing operations can be disrupted. Pressurized air is also costly to produce, so the amount of pressurized air used in the process of stripping the can body from the punch can increase manufacturing costs.

### SUMMARY OF THE INVENTION

In accordance with an aspect of the disclosed concept, a can bodymaker comprises: a ram including a punch and an air conduit, wherein the ram is structured to reciprocate; and an air strip system structured to receive pressurized air and to selectively provide the pressurized air to the punch via the air conduit to strip a can body off of the punch, wherein the air strip system includes an air strip valve disposed on a reciprocating component of the can bodymaker, wherein the air strip valve is structured to selectively open to provide pressurized air to the punch and to close to stop providing pressurized air to the punch.

In accordance with another aspect of the disclosed concept, a can bodymaker comprises: a ram including a punch and an air conduit, wherein the ram is structured to reciprocate; and an air strip system structured to receive pressurized air and to selectively provide the pressurized air to the air conduit to strip a can body off of the punch, wherein the air strip system includes an air strip valve disposed on a static component of the can bodymaker proximate the ram, wherein the air strip valve is structured to selectively open to provide pressurized air to the punch and to close to stop providing pressurized air to the punch.

In accordance with another aspect of the disclosed concept, a can bodymaker comprises: a ram including a punch and an air conduit, wherein the ram is structured to reciprocate; an air strip system structured to receive pressurized air and to selectively provide the pressurized air to the air conduit to strip a can body off of the punch, wherein the air strip system includes air strip valve is structured to selectively open to provide pressurized air to the punch and to close to stop providing pressurized air to the punch; an air strip system structured to receive pressurized air and to use the pressurized air to strip a can body off of the punch; a pressure monitor structured to sense air usage of the air strip system; and a control system structured to monitor and analyze the sensed air usage of the air strip system and to control the air strip system or can bodymaker based on the sensed air usage.

### BRIEF DESCRIPTION OF THE DRAWINGS

A full understanding of the invention can be gained from the following description of the preferred embodiments when read in conjunction with the accompanying drawings in which:

FIG. 1 is plot of air usage in an air stripping process in a bodymaker in accordance with an example embodiment of the disclosed concept;

FIG. 2 is a schematic diagram of a system for monitoring air usage in an air stripping process in a bodymaker in accordance with an example embodiment of the disclosed concept;

FIG. 3 is a view of a bodymaker in accordance with an example embodiment of the disclosed concept;

FIG. 4 is a view of a ram of a bodymaker in accordance with an example embodiment of the disclosed concept;

FIG. 5 is another view of a ram of a bodymaker in accordance with an example embodiment of the disclosed concept;

FIG. 6 is a side view of a bodymaker in accordance with an example embodiment of the disclosed concept;

FIG. 7 is a view of an air strip valve in accordance with an example embodiment of the disclosed concept;

FIG. 8 is a side view of an air strip valve in accordance with an example embodiment of the disclosed concept;

FIG. 9 is a section view of an air strip valve in accordance with an example embodiment of the disclosed concept;

FIG. 10 is a schematic diagram of a can bodymaker in accordance with an example embodiment of the disclosed concept; and

FIG. 11 is a schematic diagram of a can bodymaker in accordance with another example embodiment of the disclosed concept.

### DETAILED DESCRIPTION OF THE INVENTION

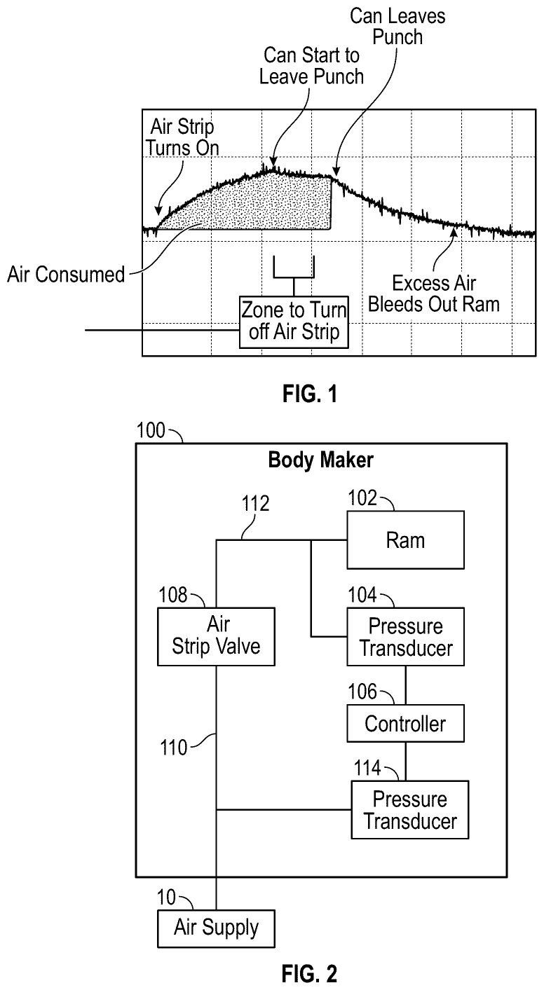

FIG. 1 is a plot of air usage in an air stripping process in a bodymaker. As shown in FIG. 1, the air usage increases when the air strip in the ram turns on. FIG. 1 also indicates points where the can body starts to leave the punch and where the can body leaves the punch. FIG. 1 further shows points where the air strip may be turned off and air usage after the can body leaves the punch from excess air bleeding out of the ram. It will be appreciated that the plot in FIG. 1 is an example and actual air usage may differ.

FIG. 2 is a schematic diagram of a bodymaker 100 in accordance with an example embodiment of the disclosed concept. The bodymaker 100 is structured to be used in the can manufacturing process and includes a ram 102 structured to reciprocate and pass a cup through a toolpack to (re)draw and iron the cup. The ram 102 includes an air conduit passing through it such that pressurized air can be passed through the ram 102 and out a distal end of the ram 102 to strip the cup off of the ram 102 after the bodymaking process. The of air to strip a cup off of the end of the ram 102 is typically referred to as air stripping or an air strip process. The bodymaker 100 is coupled to an air supply 10 which provides pressurized air for usage by the bodymaker 100. The bodymaker 100 includes a first air supply line 111 from an air inlet of the bodymaker 100 to an air strip valve 108. The bodymaker 100 further includes a second air supply line 112 from the air strip valve 108 to the ram 102. Thus, pressurized air for the air strip process is provided from the air supply 10 via the air strip valve 108. The air strip valve 108 to open to allow pressurized air to proceed to the ram 102 and to close to prevent pressurized air from proceeding to the ram 102.

The bodymaker 100 further includes a first pressure transducer 104 and a second pressure transducer 114. The bodymaker 100 also includes a controller 106. The controller 106 may include a processor and memory and be structured to receive, output, and process various electrical signals. The controller 106 may be structured to monitor and/or control various aspects of the bodymaker 100. The first pressure transducer 104 and the second pressure transducer 114 are coupled to the controller 106 and are structured to provide signals to the controller 106 indicative of pressures sensed by the first pressure transducer 104 and the second pressure transducer 114.

The first pressure transducer 104 is coupled to the second air supply line 112 and is structured to sense pressure of air in the second air supply line 112. That is, the first pressure transducer 104 is structured to sense pressure of air provided to the ram 102 in the air stripping process. The second pressure transducer 114 is coupled to the air inlet of the bodymaker 100 and is structured to sense pressure at the air inlet of the bodymaker 100. The second pressure transducer 114 is also structured to sense pressure of air provided to the ram 102 in the air stripping process. Depending on the air supply to the ram 102 for air stripping, one of the first pressure transducer 104 and the second pressure transducer 114 may be omitted without departing from the scope of the disclosed concept. For example, when the air inlet of the bodymaker 100 is used to provide pressurized air for functions in addition to air stripping, the second pressure transducer 114 may be omitted and instead the first pressure transducer 104 positioned after the air strip valve 108 should be used to sense air pressure used in the air stripping process. In the case where the air inlet is only used to provide pressurized air for the air stripping process, then either the first pressure transducer 104 or the second pressure transducer 114, or both may be used to sense air pressure used in the air stripping process.

Outputs of the first pressure transducer 104 and the second pressure transducer 114 are provided to the controller 106. That is, one or more signals of air pressure used in the air stripping process are provided to the controller 106. The one or more signals may be provided continuously or intermittently to the controller 106. The controller 106 is structured to monitor the one or more signals indicative of air pressure used in the air stripping process. In some example embodiment, the controller 106 is structured to take further actions based on the monitoring and analysis. For example, the controller 106 may monitor and analyze the one or more signals to determine air usage in the air stripping process. The controller 106 may monitor the air usage in the air stripping process to establish a baseline air usage profile that corresponds to a proper air stripping process in the bodymaker 100. The controller 106 may continue to monitor and analyze air usage in the air stripping process against the baseline to determine any improper air stripping processes. For example, when air usage deviates beyond a threshold from the baseline in a particular air stripping process, the controller 106 may determine that the air stripping process is improper. Improper air stripping processes may be due to a defect in the can, wear or improper operations of components in the bodymaker 100 used in the air stripping process, or other causes. Further, the controller 106 may establish air usage profiles for each type of improper air stripping process. When an improper air stripping process is detected, the controller 106 may compare the air usage profile in the detected improper air stripping process to air usage profiles corresponding to different types of improper air stripping processes to identify which type of improper air stripping process is currently occurring. For example, if the air usage profile compares most closely to the air usage profile corresponding to mistiming of the air strip valve 108, mistiming of the air strip valve 108 can be identified by the controller 106 from the air usage profile and appropriate action such as replacing or recalibrating the air strip valve 108 can be taken. As another example, if the air usage profile compares most closely to the air usage profile corresponding to the can body failing to be stripped from the punch of the ram 102, the can body failing to strip from the punch can be identified by the controller 106 as the improper air stripping process and appropriate remedial action can be taken. Some further examples of improper air stripping processes include low air pressure, component wear (e.g., without limitation, surface wear on the punch), and a damaged can body (e.g., without limitation, a short can or tear off where the top section of the can is torn off during the ironing process). Each improper air stripping process will generate a different air usage profile. As new improper air stripping processes are encountered, the air usage profile corresponding to that improper air stripping process may be saved by the controller 106 and used to identify when that improper air stripping process occurs again based on the air usage profile.

In response to determining an improper air stripping process, the controller 106 may be structured to save the air usage profile corresponding to the improper air stripping process. The controller 106 may be further structured to identify the type of improper air stripping process by comparing the air usage profile to saved baseline air usage profiles corresponding to different types of improper air stripping processes. The controller 106 may further be structured to take action based on the type of improper air stripping process identified. For some types of improper air stripping processes, the controller 106 may control various components of the bodymaker 100 to remedy the improper air stripping process. For example, the controller 106 may be structured to adjust timing of the air strip valve 108 in the case that the improper air stripping process is identified as mistiming of the air strip valve 108. For some types of identified improper air stripping processes, the controller 106 may be structured to output a signal identifying the type of improper air stripping process so that a technician may take any needed remedial action. In some example embodiments, the controller 106 may be structured to halt operation of the bodymaker 100 based on the type of improper air stripping process identified.

In addition to monitoring and analysis to detect and identify improper air stripping process, the controller 106 may be structured to monitor and analyze the air usage in the air stripping process to improve and optimize air usage. For example, the controller 106 may quantify the amount of pressure needed to remove a can body from the punch. The time to remove a can body from the punch can also be quantified by the controller 106. The time to reach the pressure needed to remove a can body from the punch can be quantified by the controller 106 as well. The air pressure in the ram 102 during the whole can body making process can be quantified by the controller 106. From these and other determined values, the air consumption needed to properly strip can bodies from the ram 102 can be optimized, as well as operations of the bodymaker 100. For example, the air pressure provided for the air stripping process can be controlled to a minimal amount needed to properly strip can bodies from the ram 102, thus reducing pressurized air usage. As another example, the condition of the ram 102 may be monitored based on the air usage, and the wear of components can be monitored and action can be taken to replace those components before failure. Further, the air pressure may be adjusted to minimize air usage based on the speed of operation of the bodymaker 100. For example, at a higher rate, the air pressure may be increased so that sufficient pressure is reached in the air stripping process to strip can bodies before the next can body is loaded onto the ram 102. Similarly, the air pressure may be lowered for lower rates of operation. It will be appreciated that the controller 106 may be structured monitor and analyze such parameters and may be structured to adjust air pressure or other parameters based monitored air pressure in the air stripping process.

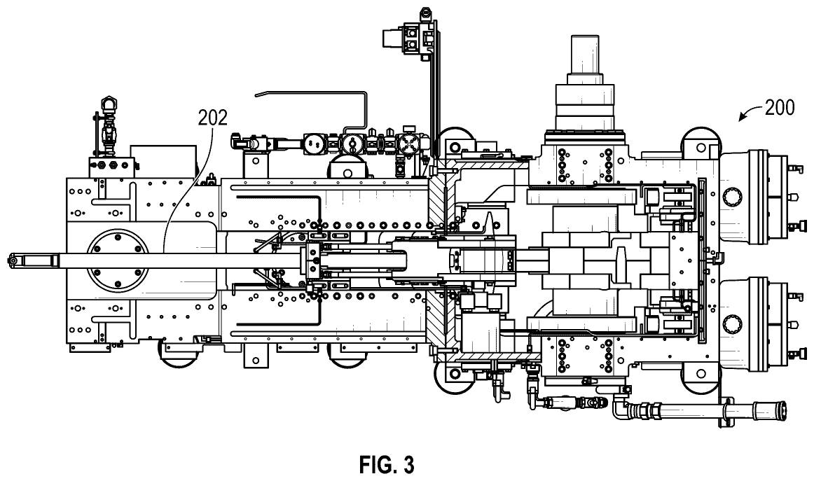

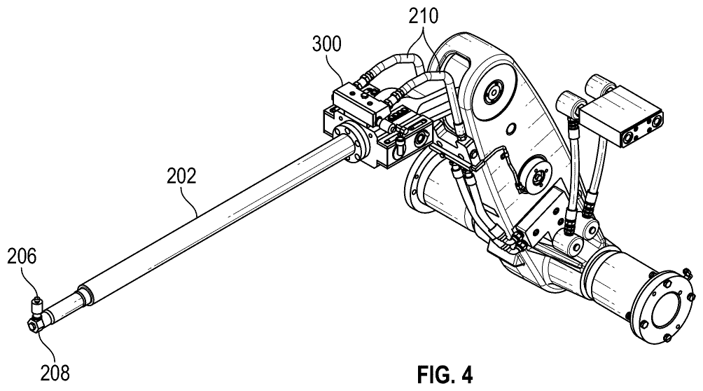

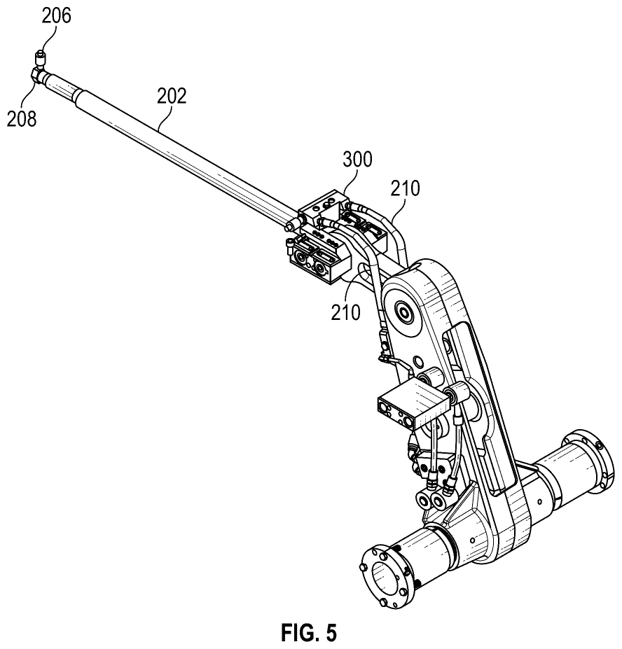

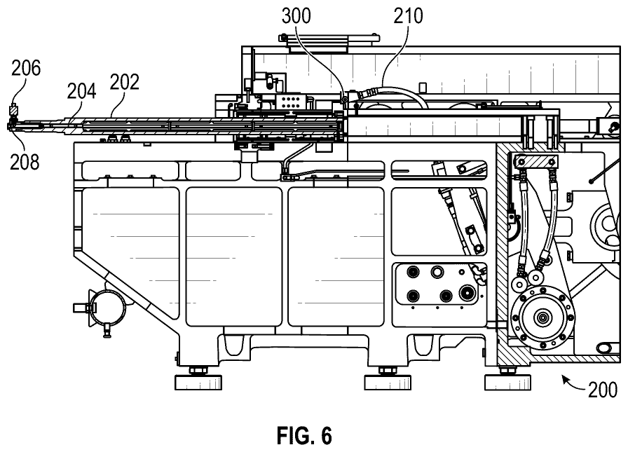

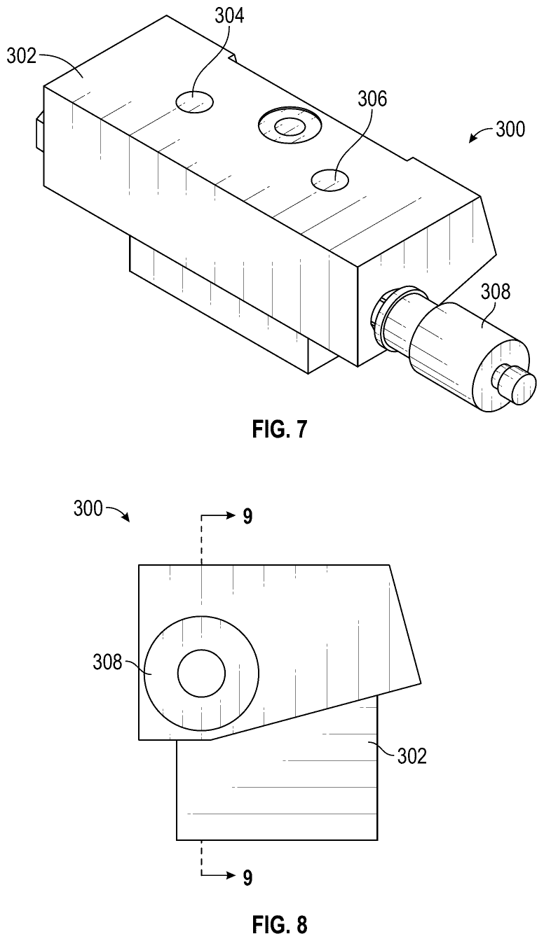

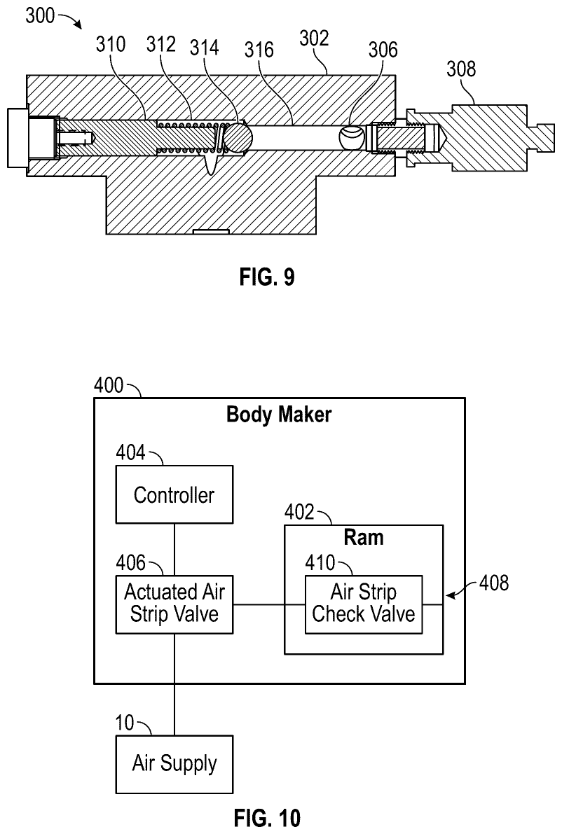

FIG. 3 is a view of a bodymaker 200 in accordance with an example embodiment of the disclosed concept. FIG. 4 is a view of a ram 202 of the bodymaker 200 in accordance with an example embodiment of the disclosed concept. FIG. 5 is another view of the ram 202 of the bodymaker 200 in accordance with an example embodiment of the disclosed concept. FIG. 6 is a side view of the bodymaker 200 in accordance with an example embodiment of the disclosed concept. FIG. 7 is a view of an air strip valve 300 in accordance with an example embodiment of the disclosed concept. FIG. 8 is a side view of the air strip valve 300 in accordance with an example embodiment of the disclosed concept. FIG. 9 is a section view of the air strip valve 300 in accordance with an example embodiment of the disclosed concept.

FIGS. 3-9 show an example embodiment of a bodymaker 100 that reduces air usage in the air stripping process. As shown, for example, in FIG. 6, the bodymaker 100 includes the ram 202. The ram 202 includes an air conduit 204 that passes through the ram 202 to a distal punch 208 at the distal end of the ram 202. Thus, pressurized air can be provided through the air conduit 204 in the ram 202 to air strip a can body off of the punch 208. A pressure sensor 206 may be disposed proximate the punch 208 and structured to sense air pressure used in the air stripping process.

In some example embodiments, the air strip valve 300 may be disposed on a static (i.e., non-reciprocating) component of the bodymaker 100 proximate the ram 202. The air strip valve 300 may be coupled to the ram 202 such that the air strip valve 300 may provide pressurized air to the air conduit 204 of the ram 202. The air strip valve 300 may be coupled to air supply lines 210 which provide pressurized air to the air strip valve 300.

FIGS. 7-9 show an example embodiment of the air strip valve 300. The air strip valve 300 includes a manifold body 302 with a hollow interior area. Inlets 304 and 306 are disposed on the manifold body 302 and are structured to coupled to the air supply lines 210 such that pressurized air from the air supply lines 210 may be passed through the inlets 304 and 306 to the hollow interior area. Opposite the inlets 304 and 306 is an outlet structured to allow pressurized air to exit the interior hollow area and proceed to the air conduit 204 of the ram 202 to be used for the air stripping process.

The air strip valve 300 is operable as a check valve. In some example embodiments, the air strip valve 300 requires a threshold pressure level of pressurized air to open. When the air strip valve 300 is closed, pressurized air cannot pass through the air strip valve 300 to the air conduit 204 of the ram 200. When the air strip valve 300 is open, pressurized air can pass through the air strip valve 300 to the air conduit 204 of the ram 200. In some example embodiments, the threshold pressure level of pressurized air to open the air strip valve 300 is 20 pounds per square inch (PSI). That is, when pressurized air having a pressure level of less than 20 PSI is provided at the inlets 304 and 306 of the air strip valve 300, the air strip valve 300 will remain closed and will not allow the pressurized air to proceed out the outlet of the air strip valve 300. When pressurized air having a pressure level of 20 PSI or more is provided at the inlets 304 and 306 of the air strip valve 300, the air strip valve 300 will open and allow the pressurized air to proceed through the air strip valve and out the outlet to the air conduit 204 of the ram 200. Thus, the air strip valve 300 may be considered pneumatically activated as providing a pneumatic signal of a threshold pressure level will cause the air strip valve 300 to open. It will be appreciated that other pressure levels may be used as the threshold pressure level.

As shown in FIG. 9, the inlets 304 and 306 and the outlet are coupled to a hollow central area of the air strip valve 300. In FIG. 9, the air strip valve 300 is shown in a closed position. The hollow central area includes a wide diameter portion and a narrow diameter portion. A spacer 310, a spring 312, and a ball bearing 314 are disposed in the wide diameter portion. The spring 312 is disposed around an end portion of the spacer 310 and is structured to bias the ball bearing 314 toward the narrow diameter portion. The ball bearing 314 has a diameter greater than the diameter of the narrow diameter portion. In the closed position, the ball bearing 314 is biased against an opening of the narrow diameter portion to prevent pressurized air from proceeding from the inlet 306 to the wide diameter portion and the outlet. To move to the open position, pressurized air is provided at the inlet 306 that has sufficient pressure to overcome the bias of the spring 312 and push the ball bearing 314 away from the opening of the narrow diameter portion. Once the pressure falls below the threshold pressure level, the spring 312 will again press the ball bearing 314 into the opening of the narrow diameter portion and prevent passage of air into the wide diameter portion.

The bodymaker 200 may include an electronically operated valve coupled to the air supply lines 300. The electronically operated valve may operate in response to an electronic signal. For example, the electronically operated valve may include a solenoid controlled by an electronic signal to open and close the valve. The electronically operated valve may be controlled to selectively apply the threshold pressure level to the inlets 304 and 306 of the air strip valve 300, and thus pneumatically control opening and closing of the air strip valve 300. Because the air strip valve 300 automatically closes when the pressure level falls below a threshold level, and because the strip valve 300 is disposed close to the ram 200, the amount of air that bleeds out of the pneumatic circuit and is wasted after air stripping is reduced.

In some example embodiments, pressure sensors may be disposed at parts of the bodymaker 200 to monitor air usage in the air stripping process. For example, the bodymaker 200 includes pressure sensors 206 and 308. Pressure sensor 206 is disposed proximate the punch 208 and pressure sensor 308 is disposed proximate the air strip valve 300. The pressure sensors 206 and 308 may be used to monitor air usage at various points in the air stripping process.

Reduction of pneumatic circuit volume reduces total air flow rate required to operate the air strip process of the bodymaker. After a can is made in a bodymaker, a solenoid valve opens and pressurized air is fed to the inside of the can to encourage it to slide off of the punch. Once the can has been fully removed from the punch, the air circuit is open and all of the pressurized air is vented to atmosphere. When the next can is made and is ready to be stripped, a solenoid valve again opens to fill the internal volume of the system and again encourage the can to slide off the punch. Because the internal volume of the system has to be filled each time a can is to be stripped, the total volume of the pneumatic circuit, along with the rate at which cans are made, drives the total flow rate of air required to operate the air strip. Pressurized air is very costly to produce, so there is great economic incentive to reduce the amount of air consumed when running any machine. By limiting the internal volume of the pneumatic circuit, the air flow rate requirement can be reduced. Examples of ways to reduce the internal volume of the pneumatic circuit include reducing the diameter of the lines in the circuit and reducing the total length of the circuit.

In accordance with example embodiments of the disclosed concept, the reduction of diameter of the lines in the pneumatic circuit may be optimized. For example, using the air usage monitoring process described herein, an optimal diameter of lines may be determined and implemented. The smaller the diameter of the lines in the circuit, the lower maximum air flow rate through the circuit will be, which means that the rate of pressure rise of air inside the can body will be slower and issues may be encountered when trying to strip a can body very quickly. Using larger diameter pneumatic lines will increase the maximum flow rate of air through system so that can bodies may be stripped very quickly. However, this also means that the internal volume of the circuit will be larger and the total flow rate to operate the air strip will increase. For example, through monitoring air usage, a minimal feed line diameter that is sufficient to allow stripping of can bodies commensurate with the operating speed of the bodymaker may be determined and implemented to optimize the diameter of the feed lines in the pneumatic circuit, thus reducing and optimizing air usage in the air stripping process.

Reduced total circuit length also reduces the internal volume of the system. Placement of the air strip valve as close as possible to the punch will reduce the internal volume. In some example embodiments of the disclosed concept, the air strip valve is placed on a static component as close as possible to the punch. A static component refers to a non-reciprocating component of the bodymaker. For example, in the example embodiment shown in FIGS. 3-9, the air strip valve 300 is placed on a static component proximate the ram 200, thus reducing total circuit length.

In some example embodiments, the air strip valve is placed on a reciprocating component of the bodymaker (e.g., without limitation, ram, slide yoke, conrod, swing lever, etc.) closer to the punch. In these example embodiments, the air strip valve may be a mechanical or electronically (wired or wireless) controlled valve. These embodiments further reduce the internal volume of the pneumatic circuit. In some further example embodiment, the air strip valve is placed on a static component and a further check valve is placed on a reciprocating component. For example, a check valve may be placed on the ram to prevent air from bleeding out of the ram after air stripping is completed. Placing the air strip valve on a static component makes it easier to control (e.g., provide a control signal to) and actuate the air strip valve. The check valve may then be placed much more closely to the punch to limit the overall system volume. In this way the check valve receives a pneumatic signal for when to open which is not difficult to transmit through reciprocating components. Check valves often rely on a sprung mechanism which can be susceptible to the high accelerations sustained by bodymaker reciprocating components. In some example embodiments, the axis of actuation of the check valve is perpendicular to the movement of the bodymaker components to which it is attached so that the acceleration of the bodymaker components do not affect the actuation of the check valve.

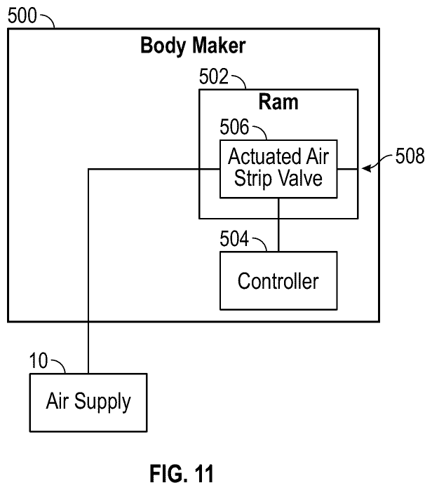

FIGS. 10 and 11 are schematic diagrams of bodymakers that use a reduced amount of air in the air stripping process. In FIG. 10, a bodymaker 400 includes an actuated air strip valve 406 supplied by an air supply 10. The bodymaker 400 includes an air strip check valve 408 disposed on a ram 402 proximate an air outlet 408 for air stripping. The bodymaker 400 further includes a controller 404 structured to control the actuated air strip valve 406. The actuated air strip valve 406 may be an electronically controlled valve controlled by the controller 404. The actuated air strip valve 406 is structured to be electronically controlled to selectively provide pressured air to the air strip check valve 408 for use in the air stripping process. When the actuated air strip valve 406 is opened, pressurized air is provided to the air strip check valve 408, which will open in response to the pressurized air and provide air for air stripping a can from the ram 402. When the actuated air strip valve 406 is closed, the air strip check valve 408 will also close and prevent bleed out of air. Thus, the bodymaker 400 reduces the total circuit length and reduces waste of air in the air stripping process.

In FIG. 11, a bodymaker 500 includes an actuated air strip valve 506 disposed on a ram 502 proximate an air outlet 508 for air stripping and structured to receive pressurized air from the air supply 10. The bodymaker 500 includes a controller 504 structured to electronically control opening and closing of the actuated air strip valve 506. In some example embodiments, the controller 504 may have a wired connection to the actuated air strip valve 506 to control the actuated air strip valve 506. In some example embodiments, the actuated air strip valve 506 is structured to be wirelessly controlled and the controller 504 is structured to wirelessly control the actuated air strip valve 506. By placing the actuated air strip valve 508 proximate the air outlet 508 of the ram 502, the amount of air that bleeds out during air stripping is reduced.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of disclosed concept which is to be given the full breadth of the claims appended and any and all equivalents thereof.

What is claimed is:

1. A can bodymaker comprising:
a ram including a punch and an air conduit, wherein the ram is structured to reciprocate; and
an air strip system structured to receive pressurized air and to selectively provide the pressurized air to the punch via the air conduit to strip a can body off of the punch,
wherein the air strip system includes an air strip valve disposed on a reciprocating component of the can bodymaker, wherein the air strip valve is structured to selectively open to provide pressurized air to the punch and to close to stop providing pressurized air to the punch.

2. The can bodymaker of claim 1, wherein the air strip valve is a check valve structured to open and provide the pressurized air to the air conduit in response to the pressurized air reaching a threshold pressure level.

3. The can bodymaker of claim 2, wherein the threshold pressure level is 20 pounds per square inch.

4. The can bodymaker of claim 2, wherein the air strip system includes an actuated air strip valve structured to be electronically controlled to selectively provide the pressurized air at or above the threshold pressure level to the air strip valve, wherein the actuated air strip valve is disposed on a static component of the can bodymaker.

5. The can bodymaker of claim 1, wherein the air strip valve is an actuated air strip valve structured to be electronically controlled to selectively open to provide pressurized air to the punch and to close to stop providing pressurized air to the punch.

6. The can bodymaker of claim 5, wherein the air strip valve is structured to be wirelessly electronically controlled.

7. The can bodymaker of claim 1, wherein the air strip valve is a check valve and includes:
a manifold body including an inlet structured to receive the pressurized air;
an outlet structured to provide pressurized air to the punch;
a hollow interior area disposed between the inlet and the outlet;
a ball bearing disposed in the hollow interior area; and
a spring disposed in the hollow interior area and structured to bias the ball bearing to block a path between the inlet and the outlet,
wherein the spring is structured such that the pressurized air at the threshold pressure level will overcome the bias of the spring and push the ball bearing to create open the path between the inlet and the outlet.

8. The can bodymaker of claim 1, wherein the air strip valve is disposed on the ram.

9. A can bodymaker comprising:
a ram including a punch and an air conduit, wherein the ram is structured to reciprocate; and
an air strip system structured to receive pressurized air and to selectively provide the pressurized air to the air conduit to strip a can body off of the punch,
wherein the air strip system includes an air strip valve disposed on a static component of the can bodymaker proximate the ram, wherein the air strip valve is structured to selectively open to provide pressurized air to the punch and to close to stop providing pressurized air to the punch.

10. The can bodymaker of claim 9, wherein the air strip valve is a check valve structured to open and provide the pressurized air to the air conduit in response to the pressurized air reaching a threshold pressure level.

11. The can bodymaker of claim 10, wherein the threshold pressure level is 20 pounds per square inch.

12. The can bodymaker of claim 10, wherein the air strip system includes an actuated air strip valve structured to be electronically controlled to selectively provide the pressurized air at or above the threshold pressure level to the air strip valve.

13. The can bodymaker of claim 9, wherein the air strip valve is a check valve and includes:
a manifold body including an inlet structured to receive the pressurized air;
an outlet structured to provide pressurized air to the punch;
a hollow interior area disposed between the inlet and the outlet;
a ball bearing disposed in the hollow interior area; and
a spring disposed in the hollow interior area and structured to bias the ball bearing to block a path between the inlet and the outlet,
wherein the spring is structured such that the pressurized air at the threshold pressure level will overcome the bias of the spring and push the ball bearing to create open the path between the inlet and the outlet.

14. A can bodymaker comprising:
a ram including a punch and an air conduit, wherein the ram is structured to reciprocate;
an air strip system structured to receive pressurized air and to selectively provide the pressurized air to the air conduit to strip a can body off of the punch, wherein the air strip system includes air strip valve is structured to selectively open to provide pressurized air to the punch and to close to stop providing pressurized air to the punch;
an air strip system structured to receive pressurized air and to use the pressurized air to strip a can body off of the punch;
a pressure monitor structured to sense air usage of the air strip system; and
a control system structured to monitor and analyze the sensed air usage of the air strip system and to control the air strip system or can bodymaker based on the sensed air usage.

15. The can bodymaker of claim 14, wherein the pressure monitor is a pressure transducer.

16. The can bodymaker of claim 14, wherein the pressure monitor is disposed between the air strip valve and the punch.

17. The can bodymaker of claim 16, wherein the pressure monitor is a first pressure monitor, and wherein the can bodymaker includes a second pressure monitor disposed at an inlet of the can bodymaker and structured to sense air usage of the can bodymaker.

18. The can bodymaker of claim 14, wherein the controller is structured to establish a baseline air usage profile corresponding to air usage of the air strip system when properly stripping the can body off of the punch.

19. The can bodymaker of claim 18, wherein the controller is structured to sense air usage of the air strip system during stripping a selected can body off of the punch, to compare the sensed air usage to the baseline air usage profile, and to determine whether the selected can body was properly stripped off of the punch based on the comparison of the sensed air usage to the baseline air usage profile.

20. The can bodymaker of claim 19, wherein the controller is structured to establish improper air usage profiles corresponding to selected types of improper stripping operations, and in response to determining the selected can body was not properly stripped off of the punch, to compare the sensed air usage to the improper air usage profiles, and to determine a type of improper stripping operation based on the comparison of the sensed air usage to the improper air usage profiles.
